(19) United States
(12) Patent Application Publication
(10) Pub. No.: US 2023/0070627 A1
(43) Pub. Date: Mar. 9, 2023

(54) TIMEPIECE MODULE

(71) Applicant: ROLEX SA, Geneva (CH)

(72) Inventor: William Carreno, Geneva (CH)

(73) Assignee: ROLEX SA, Geneva (CH)

(21) Appl. No.: 17/939,157

(22) Filed: Sep. 7, 2022

(30) Foreign Application Priority Data
Sep. 8, 2021 (EP) 21195559.6

(51) Int. Cl. G04B 15/08; G04B 29/02; G04B 17/06; G04B 18/02

(52) U.S. Cl. CPC G04B 15/08; G04B 29/022; G04B 17/06; G04B 18/02

(57) ABSTRACT

Timepiece module (300) including a mobile (100), a first bridge (34), a second bridge (36), and a positioning system (150) for positioning the second bridge (36) on the first bridge (34), the positioning system (150) including positioning elements (31a, 31b) each one including a first positioning portion (312a, 312b) for positioning the first bridge (34), a second positioning portion (314a, 314b) for positioning the second bridge (36), and a third positioning portion (311a, 311b) able to position the positioning element (31a, 31b) relative to a frame (99), notably relative to a bridge or to a manipulate (4).

This application claims priority of European patent application No. EP21195559.6 filed Sep. 8, 2021, the content of which is hereby incorporated by reference herein in its entirety.

### BACKGROUND ART

The invention relates to a timepiece module. The invention also relates to a timepiece assembly, notably a timepiece movement, comprising such a timepiece module. The invention also relates to a timepiece comprising such a timepiece module or such a timepiece assembly. The invention finally relates to a method for assembling a timepiece assembly or a timepiece.

Document EP2238518 relates to a modular timepiece movement making it possible to display, on the one same mainplate, a number of time indications in various configurations. To do this, the movement comprises at least two modules that can be positioned one relative to the other in different positions. According to one preferred embodiment, the first module may be a basic module comprising at least a mainplate and a barrel. The second module may comprise at least one finishing geartrain kinematically connected to a mobile of the first module. This second module also comprises a regulating system made up of an escapement device and of an oscillator of the balance-spring type. The geartrain mobiles are pivoted between a bottom plate and a top plate, whereas the oscillator is pivoted between the bottom plate and a balance cock and the pallet fork of the escapement device is pivoted between the bottom plate and a pallet bridge. The positioning of said bottom plate relative to the top plate is achieved here through the intermediary of screw-feet. These same screw-feet allow the mainplate to be positioned relative to the first and second plates. Nevertheless, the fixing, particularly the screwing, of the bottom plate to the top plate cannot be performed independently of the mainplate, as the latter is needed for fixing, particularly screwing, the bottom plate to a given screw-foot.

Thus, the assembly of the second module is dependent on the first module, particularly on the mainplate of the first module. Furthermore, the balance cock and the pallet bridge are positioned on the bottom plate independently of the screw-feet but allow the relative positioning of the bottom and top plates on the mainplate.

Document CH700660 discloses a regulating system module which itself takes the form of an autonomous module. It comprises a bottom bridge on which there are mounted a balance bridge, a pallet bridge, and an escapement bridge. Each of these elements is guided and fixed to the bottom bridge by means of distinct guiding and fixing elements. Moreover, the bottom bridge is positioned and fixed to the mainplate of a timepiece movement by dedicated guiding and fixing elements. Such a module is also known from the Moser company. That module is notably incorporated into the caliber HMC 343 manual rewind movement.

Document EP2565730 itself discloses a regulating system module which is remarkable in that all the components of the regulating member are designed to allow automated assembly from the one same side of the module. This module comprises a bottom bridge and a top bridge on the latter of which are mounted both the elements of the escapement device and those of the balance-spring type oscillator. The top bridge is positioned on the bottom bridge by dedicated positioning studs which perform no other function.

### SUMMARY OF THE INVENTION

The object of the invention is to provide a timepiece module that improves the timepiece devices known from the prior art. In particular, the invention proposes a timepiece module that makes it possible to perform adjustment operations within the timepiece module before the latter is integrated easily into a timepiece. It allows precise assembly of the components within said module and precise and easy assembly of said module within a movement or a timepiece.

According to the invention, a timepiece module is defined by point 1 below.
1. A timepiece module comprising:
   a mobile,
   a first bridge,
   a second bridge, and
   a positioning system for positioning the second bridge on the first bridge,
   the positioning system comprising positioning elements each one comprising:
   a first positioning portion for positioning the first bridge,
   a second positioning portion for positioning the second bridge, and
   a third positioning portion able to position the positioning element relative to a frame, notably relative to a bridge or to a mainplate.

Embodiments of the module are defined by point 2 to 11 below.
2. The timepiece module as defined in the preceding point, wherein the positioning system comprises second fixing elements for fixing the second bridge on the first bridge, notably screws, each one collaborating with a second fixing portion, notably a tapped hole, provided on each positioning element.
3. The timepiece module as defined in one of the preceding points, wherein the first positioning portion is a cylindrical or partially cylindrical portion intended to collaborate with a first opening, such as a first bore, provided in the first bridge.
4. The timepiece module as defined in one of the preceding points, wherein the second positioning portion is a cylindrical or partially cylindrical portion intended to collaborate with a second opening, such as a second bore, provided in the second bridge.
5. The timepiece module as defined in one of the preceding points, wherein the third positioning portion is a cylindrical or partially cylindrical portion intended to collaborate with a protruding element, such as a pin, provided on or attached to a frame.
6. The timepiece module as defined in one of the preceding points, wherein the positioning elements are screw-feet.
7. The timepiece module as defined in one of the preceding points, wherein said module comprises a third bridge positioned between the first bridge and the second bridge.
8. The timepiece module as defined in the preceding point, wherein the positioning elements each comprise a fourth positioning portion for positioning the third bridge.
9. The timepiece module as defined in one of the preceding points, wherein the positioning system comprises first fixing elements, notably nuts, each collaborating with a first fixing portion, notably with a threaded portion, provided on each positioning element.
10. The timepiece module as defined in one of the preceding points, wherein the module is a regulating system module and/or wherein the mobile is an oscillator, particularly an assembly comprised of balance and balance spring.
11. The timepiece module as defined in one of the preceding points, wherein the timepiece module further comprises an escapement device, particularly a tangentially driven escapement device or a Swiss lever escapement device.

According to the invention, a timepiece assembly is defined by point 12 below.
12. An assembly, particularly a timepiece movement, comprising a timepiece module as defined in one of the preceding points and a frame, notably a bridge or a mainplate.

One embodiment of a timepiece assembly is defined by point 13 below.
13. The assembly as defined in the preceding point, wherein the frame comprises two positioning elements taking the form of protruding elements arranged in such a way as to have respective longitudinal ends positioned in distinct parallel plans, these distinct parallel planes being notably parallel to a plane in which the frame extends and/or perpendicular to a geometric axis of a positioning element.

According to the invention, a timepiece is defined by point 14 below.
14. A timepiece, notably a wristwatch, comprising a timepiece module as defined in one of points 1 to 11 and/or an assembly as defined in point 12 or 13.

According to the invention, a method for assembling an assembly is defined by point 15 below.
15. A method for assembling an assembly, notably an assembly as defined in point 12 or 13 or a timepiece as defined in point 14, comprising the following steps:
   supplying a timepiece module, notably a timepiece module as defined in one of points 1 to 11;
   supplying a frame;
   mounting the timepiece module such that it can pivot on the frame, notably so as to pivot about a positioning element;
   positioning the module relative to the frame by means of the positioning elements; and
   fixing the timepiece module in this position relative to the frame.

### BRIEF DESCRIPTION OF THE DRAWINGS

The attached drawings depict, by way of examples, two embodiments of a timepiece.

FIG. 1 is a perspective view of a first embodiment of a timepiece.

FIG. 2 is an exploded perspective view of a first embodiment of a timepiece module.

FIGS. 3 to 5 are views in cross section of the first embodiment of a timepiece.

FIG. 6 is a view in cross section of a variant of the first embodiment of a timepiece.

FIGS. 7 to 11 are various views illustrating the sitting of the first embodiment of a timepiece module to form the first embodiment of a timepiece.

FIG. 12 is an exploded perspective view of a second embodiment of a timepiece module.

FIG. 13 is a view from above depicting a second embodiment of a timepiece.

### DETAILED DESCRIPTION OF PARTICULAR EMBODIMENTS

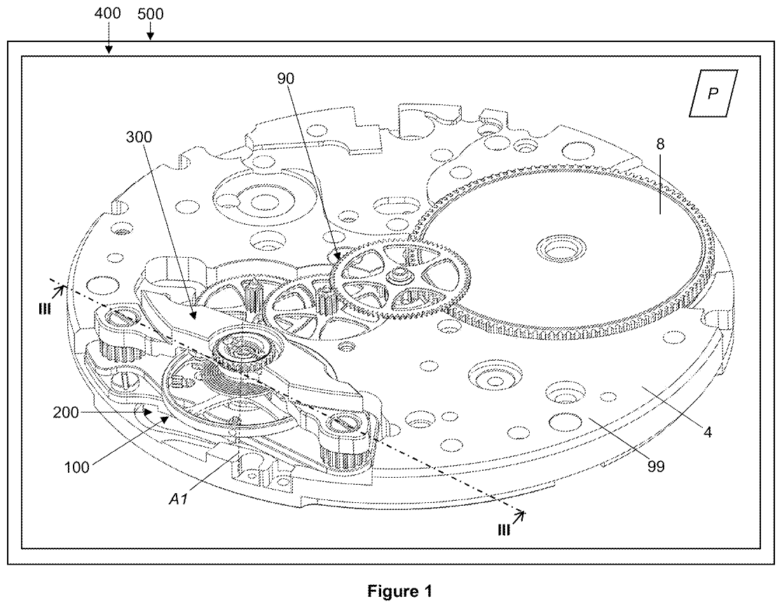

A first embodiment of a timepiece 500 is described in detail hereinbelow with reference to FIGS. 1 to 11. The timepiece 500 is, for example, a watch, particularly a wristwatch. The timepiece 500 comprises an assembly 400, particularly a timepiece movement 400, intended to be mounted in a timepiece case or casing to protect it from the external environment. The timepiece movement 400 may be a mechanical movement, notably an automatic movement, or else a hybrid movement.

The assembly 400 comprises a timepiece module 300 and a timepiece movement frame 99, notably a bridge of the timepiece movement or a mainplate 4 of the timepiece movement. The timepiece module is advantageously positioned and fixed on the frame. For example, the timepiece module 300 may be a regulating system module. This module may be designed to be assembled within the movement 400 of the timepiece 500, particularly on the frame 99, notably on a mainplate 4 of said movement. The timepiece module advantageously comprises a mobile 100, particularly an oscillator 100, and an escapement device 200. As a preference, the oscillator 100 takes the form of an oscillator comprising a balance 11 and a balance spring 12 which are assembled on a staff or an arbor 13 of geometric axis A1 perpendicular to a plane P in which the mainplate 4 of the movement 400 extends.

For example, the escapement device 200 is a tangentially driven escapement as described in application EP3637195.

FIG. 1 illustrates a general arrangement of the timepiece 500 of which the movement 400 comprises a finishing geartrain 90, which connects a barrel 8 to a regulating system provided with the escapement device 200 and with the oscillator 100, both positioned within the timepiece module 300. The geartrain 90 and the barrel 8 are positioned in the frame 99, particularly on the mainplate 4.

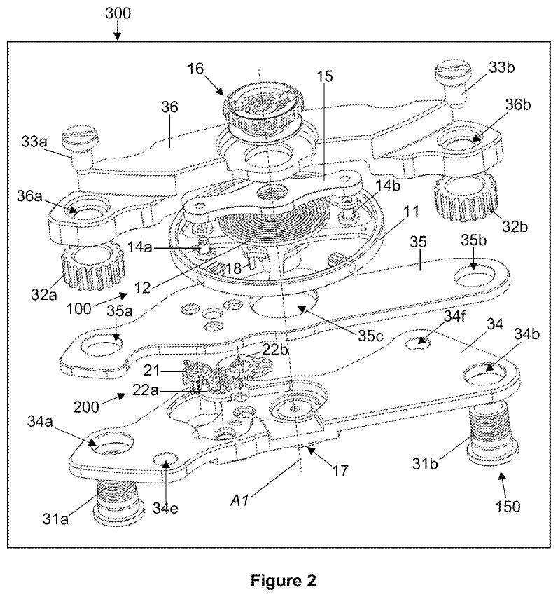

The timepiece module 300 is more particularly detailed in the exploded view that is FIG. 2.

The timepiece module 300 comprises
the mobile 100, notably the oscillator 100,
a first bridge 34,
a second bridge 36, and
a positioning system 150 for positioning the second bridge 36 on the first bridge 34.

The positioning system 150 comprises positioning elements 31a, 31b each comprising:
a first positioning portion 312a, 312b for positioning the first bridge 34,
a second positioning portion 314a, 314b for positioning the second bridge 36, and
a third positioning portion 311a, 311b able to position the positioning element 31a, 31b relative to the frame 99, notably relative to a bridge or to the mainplate 4.

The first positioning portion 312a, 312b allows the first bridge 34 to be positioned relative to the positioning elements 31a, 31b.

The second positioning portion 314a, 314b allows the second bridge 36 to be positioned relative to the positioning elements 31a, 31b.

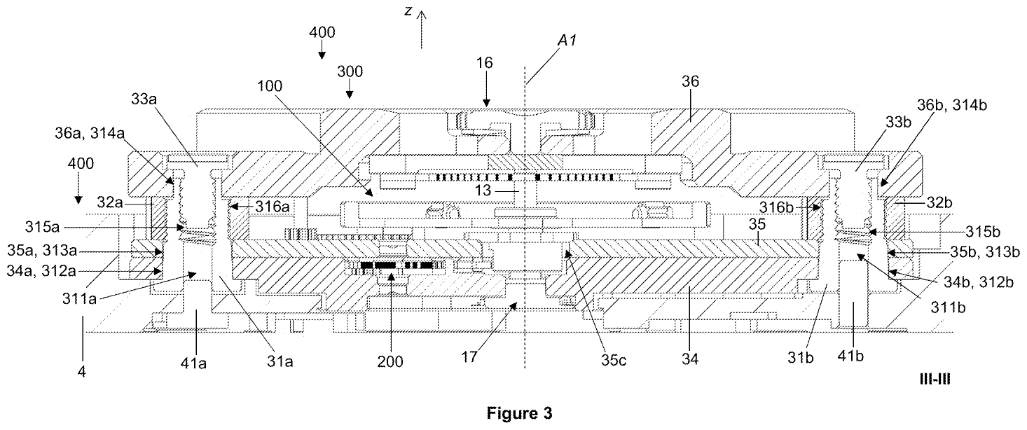

In this first embodiment, the positioning elements are two in number. Alternatively, the number of positioning elements may be different, notably three. As a preference, the positioning elements are screw-feet 31a, 31b. These comprise cylindrical or partially cylindrical portions or openings 311a, 311b constituting the third positioning portion. Positioning elements 41a, 41b, notably protruding elements 41a, 41b such as pins 41a, 41b provided on or attached to the frame, are provided for collaborating with the third positioning portions 311a, 311b when the module 300 is being assembled within the movement 400. As is more particularly visible in the view in cross section that is FIG. 3, two positioning elements 41a, 41b are notably provided to be inserted into the third respective positioning portions 311a, 311b of two positioning elements 31a, 31b.

The two screw-feet 31a, 31b are also intended for positioning the bridges of the timepiece module 300 with respect to one another. The module 300 here comprises three bridges 34, 35, 36. In particular, these are through-bridges, notably of elongate shape. More particularly, these bridges here are symmetrical or substantially symmetrical with respect to a plane through which the geometric axis A1 of the staff 13 of the oscillator 100 passes.

The bridge 34 acts as a base on which the constituent elements of the escapement device 200 and of the oscillator 100 are positioned, particularly the three mobiles 21, 22a, 22b of the escapement device 200 and the staff 13 of the oscillator 100.

The bridge 35 is intended for pivoting the mobiles 21, 22a, 22b of the escapement device 200, in collaboration with the bridge 34. More particularly, these mobiles are arbor-set mobiles each comprising a first end pivoted by the bridge 34, and a second end pivoted by the bridge 35. The bridge 35 thus acts as escapement bridge. The bridge 35 is advantageously positioned between the bridge 34 and 36.

The bridge 36 is itself intended for pivoting the staff 13 of the oscillator 100, in collaboration with the bridge 34. More particularly, a first end of the staff 13 is pivoted by the bridge 34, notably via a bearing 17 mounted on the bridge 34, and a second end of the staff 13 is pivoted by the bridge 36, notably by a bearing 16 mounted on the bridge 36. The bridge 36 thus acts as balance bridge.

In a simplified variant of the timepiece module 300, it will be possible to combine the functions of the bridges 35 and 36 in order to employ just one single bridge that pivots both the elements of the escapement device and those of the oscillator.

The two screw-feet 31a, 31b are here fixed at two ends of the bridge 34. These feet are notably respectively driven into two openings 34a, 34b, notably two bores 34a, 34b, of the bridge 34 at their respective portion 312a, 312b. The first positioning portions 312a, 312b are, for example, cylindrical or partially cylindrical portions. The collaboration between the first positioning portions 312a, 312b of the two screw-feet 31a, 31b and the openings 34a, 34b of the bridge 34 thus allows the positioning elements 312a, 312b, notably the screw-feet 31a, 31b, to be positioned relative to the bridge 34. The screw-feet 31a, 31b also each comprise a fourth positioning portion 313a, 313b for positioning the third bridge 35 or a guiding portion 313a, 313b for guiding the third bridge 35. The collaboration between the fourth positioning portions 313a, 313b and the third bridge 35 thus allows said bridge 35 to be positioned relative to the positioning elements 31a, 31b, notably to the two screw-feet 31a, 31b. The screw-feet 31a, 31b also each comprise the second positioning portion 314a, 314b for positioning the second bridge 36 or a guiding portion 314a, 314b for guiding said bridge 36. The second positioning portions 314a, 314b are, for example, cylindrical or partially cylindrical portions.

The two screw-feet 31a, 31b also respectively comprise first fixing portions, notably threaded portions 316a, 316b, which are intended to collaborate with first fixing elements 32a, 32b, such as tapped spacers 32a, 32b or nuts that form part of the positioning system. These first fixing elements advantageously make it possible:
to position the balance bridge 36 with respect to the bridge 34 at a given separation in a vertical direction z parallel to the axis A1, and/or
to position the bridge 35 on the bridge 34, and/or
to complete the fixing of the screw-feet to the bridge 34, notably when the module does not have a bridge 35, which is to say when the bridge 36 acts as escapement bridge and balance bridge.

Finally, the securing of the bridges 34, 35 and 36, particularly the fixing of the bridge 36 to the bridge 34 and the possible bridge 35, is performed by means of second fixing elements 33a, 33b, such as screws 33a, 33b, which form part of the positioning system and are intended to collaborate with, notably to screw into, respective fixing portions, notably respective tapped portions 315a, 315b of the screw-feet 31a, 31b.

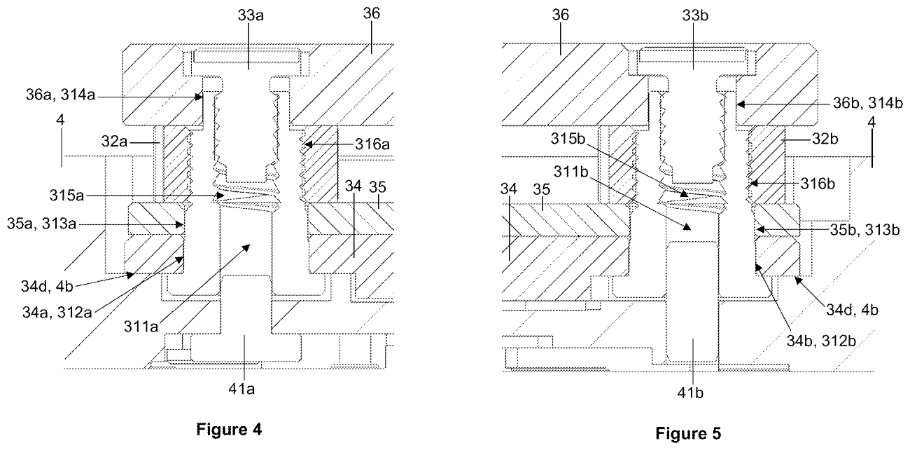

These features are more particularly visible in FIGS. 4 and 5 which are detailed views of the view in cross section that is FIG. 3.

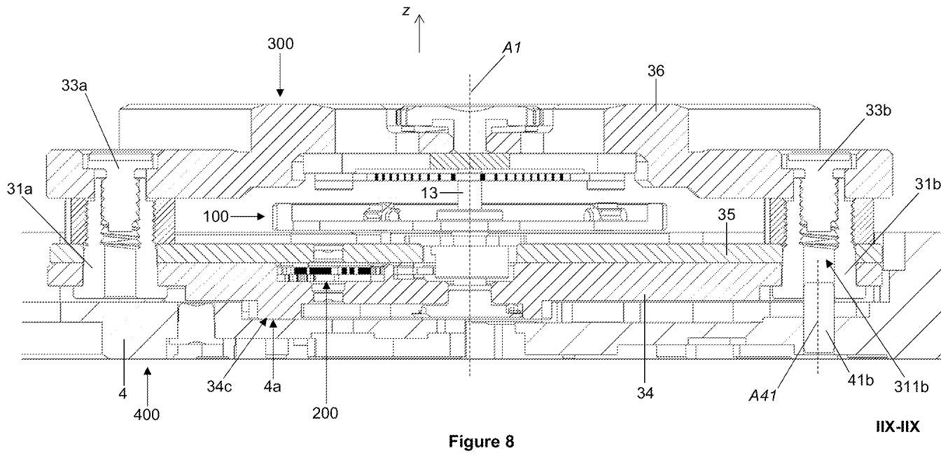

One procedure for assembling the module 300 comprises the following steps:
A first step, which is optional, involves fixing the screw feet 31a, 31b into the respective openings 34a, 34b of the bridge 34, notably by driving them in. Alternatively, these screw-feet could be formed as one with the bridge 34 or permanently fixed to the bridge 34.
The mobiles 21, 22a, 22b of the escapement device 200 are then placed on the bridge 34 at the guide bearings. The mobile 21 is an escapement mobile and the mobiles 22a and 22b are blocking mobiles kinematically connected to one another by tooth sets. At rest, the end of one tooth of the escapement mobile 21 collaborates with one or the other of the respective blocking surfaces of the blocking mobiles 22a, 22b. Thus, during the step of mounting the mobiles 21, 22a, 22b, a support provided with poka-yoke features may advantageously be employed in order to position these mobiles correctly relative to one another, notably angularly.
The bridge 35 is then assembled on the bridge 34. To do this, the bridge 35 comprises two openings 35a, 35b, positioned at two ends of said bridge, and which are intended to collaborate respectively with the screw-feet 31a, 31b at the positioning portion 313a, 313b thereof. The bridge 35 is thus positioned on the bridge 34 via the screw-feet 31a, 31b.
The spacers 32a, 32b are then screwed respectively onto the screw-feet 31a, 31b, at the fixing portions 316a, 316b thereof. This allows the bridge 35 to be pressed against the bridge 34 while at the same time ensuring that the mobiles 21, 22a, 22b have suitable clearance between the bridges 34 and 35.
The bridge 36, on which the oscillator 100 has been mounted beforehand, is then assembled on the spacers 32a, 32b so as to allow the staff 13 to pivot between the bearings 16 and 17. To do that, the bridge 35 comprises a central opening 35c through which the oscillator 100 passes, particularly the staff 13. The bridge 36 comprises two openings 36a, 36b, positioned at two ends of said bridge, and which are intended to collaborate respectively with the screw-feet 31a, 31b, at the positioning portion 314a, 314b thereof. The bridge 36 is thus positioned on the bridge 34 by means of the screw-feet 31a, 31b. Moreover, the distance between the bridge 34 and the bridge 36, in a vertical direction parallel to that of the vector z as depicted in FIG. 8, is defined here by means of the bridge 35 and of the spacers 32a, 32b.
Finally, the screws 33a, 33b are screwed into the screw-feet 31a, 31b at fixing portions, notably tapped fixing portions 315a, 315b.

At the end of this step, the module 300 constitutes an autonomous module or a subassembly of the movement. Operations of adjusting and/or lubricating the oscillator 100 and/or the escapement device 200 can thus be performed, and this can be done before the module 300 is mounted in the rest of the movement to form the movement 400.

The vertical clearance of the balance/balance-spring assembly can be adjusted for example by adjusting the vertical position of the bearing 17 in the bridge 34. The positioning may for example be performed by rotating the bearing 16 about the axis A1, as taught in document EP2799937. Specifically, according to this particular variant of the first embodiment of the module, the exterior end of the balance spring 12 is secured to the bridge 36 by a support 15 fixed to the bearing 16. More particularly, the outer end of the balance spring 12 is secured to the support 15 by fixing elements 14a, 14b and the bearing 16 is mounted with the ability to rotate on the bridge 36. Thus, a rotating of the bearing 16 causes the balance/balance-spring assembly to rotate, allowing suitable positioning of the balance plate pin 18 which is intended to collaborate with a fork of the blocking mobile 22b.

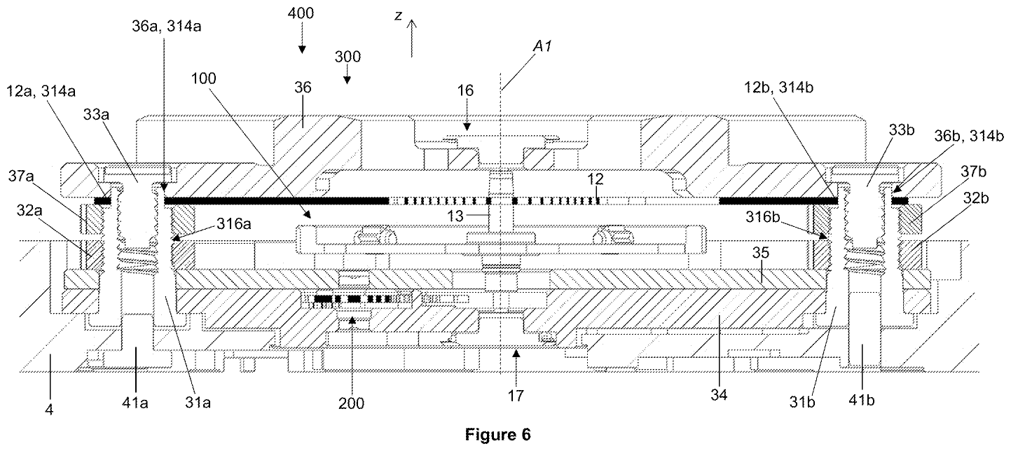

According to one particular variant embodiment of the module 300 which variant is illustrated in FIG. 6, the outer end of the balance spring 12 may be positioned with respect to the bridges 34 and 36 by means of the positioning elements 31a, 31b. To do that, the outer end of the balance spring 12 may be provided with openings 12a, 12b advantageously positioned at two ends of the outer end of the balance spring, which are intended to collaborate respectively with the screw-feet 31a, 31b at the respective guiding portions 314a, 314b which are also intended to allow the bridge 36 to be positioned with respect to the bridge 34. Of course, the guiding portions for guiding the balance spring 12 may alternatively be distinct from the guiding portions for guiding the bridge 36. Such a variant in the assembling of the oscillator 100 within the module 300 offers the notable advantage of allowing the oscillator to be positioned very precisely. It particularly offers the advantage of allowing the center of the balance plate peg to be positioned reliably and repeatably independently of any ancillary adjusting means such as a mobile support for the fixing of a balance spring. The absence of a balance spring mobile fixing support furthermore makes it possible to make the thickness of the module smaller, while at the same time allowing for easy removal and refitting of the balance/balance spring. According to this particular variant embodiment of the module 300, the balance spring preferably bears against spacers 37a, 37b screwed respectively to the threaded portions 316a, 316b of the screw-feet 31a, 31b. Such a solution allows the vertical clearance of the balance/balance spring assembly to be adjusted by adjusting the vertical position of the spacers 37a, 37b on the screw-feet 31a, 31b. To do that, the tapped thread of the spacers 37a, 37b and/or the screw thread of the portion 316a, 316b are shaped in such a way as to produce, notably by friction, a retaining torque that allows the spacers 37a, 37b to be kept reliably and repeatably in position on the screw-feet 31a, 31b. In the variant illustrated in FIG. 6, the threaded portions 316a, 316b are also intended to accept the spacers 32a and 32b which notably allow the bridge 35 to be fixed against the bridge 34. Of course, the threaded portions intended to collaborate with the spacers 37a, 37b may alternatively be distinct from the threaded portions 316a, 316b intended to collaborate with the spacers 32a, 32b.

Once the module 300 has been assembled and any adjustment and/or lubrication operations have been performed, the module 300 can be assembled within the rest of the movement, notably on the mainplate 4 to constitute the movement 400. A key difficulty lies in making the elements of the modules 300 to be able to mesh with the geartrain 90, particularly for the mobile 21 of the escapement device 200 to be able to mesh with the mobile 9 of the geartrain 90 that is furthest from the barrel 8. In order to alleviate these problems, the module 300 and the movement 400, particularly the rest of the movement 400, has special shapings that allow easy assembly of the module 300 and in particular allow the tooth sets of the mobiles 9 and 21 to interpenetrate easily upon assembly of the module 300.

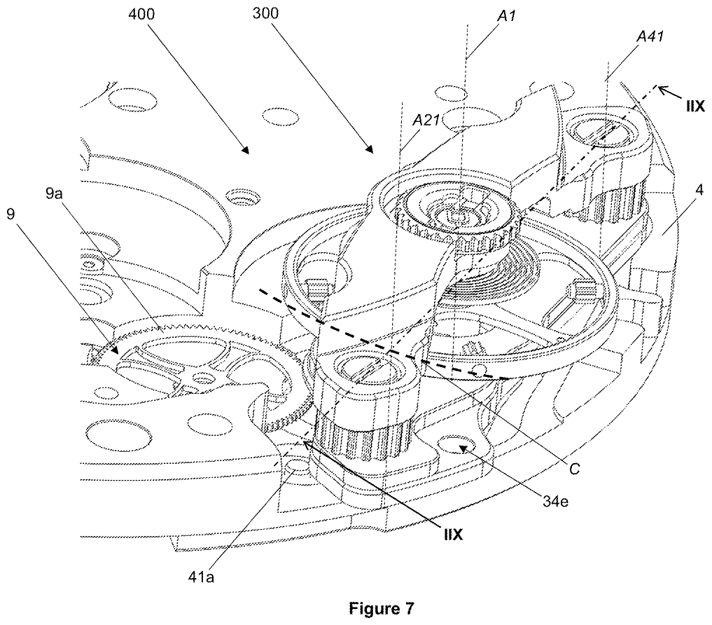

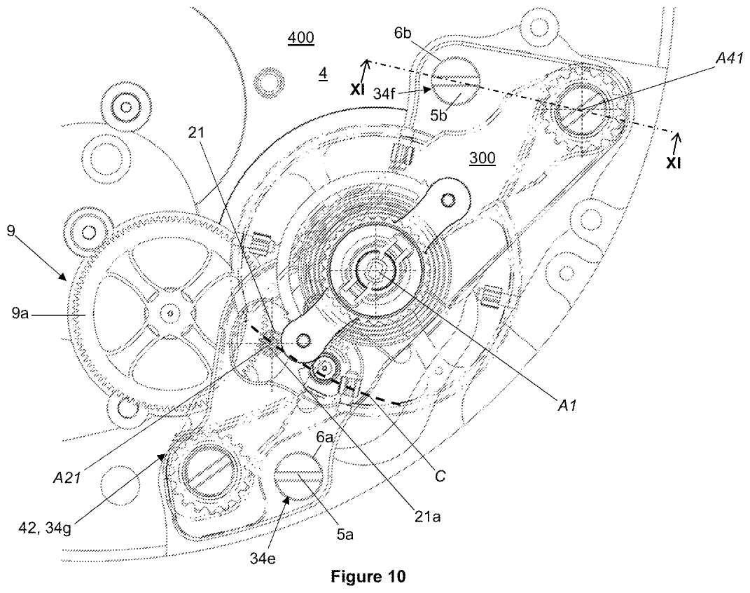

More particularly, these shapings make it possible to define a method for mounting the module 300 on the mainplate 4, which method comprises at least a step of rotating the module 300 about a positioning element 41a or 41b of the mainplate 4, notably a protruding element 41a or 41b such as a pin. According to the embodiment illustrated in the figures, notably FIGS. 7 to 11 which depict the mounting method, the rotating of the module 300 is performed about the pin 41b of geometric axis A41. Such a step allows the mobile 21, particularly the pinion 21a (as visible in FIG. 10), to be moved closer to the mobile 9, particularly the wheel 9a, along a circular path C centered on the axis A41 and passing through an axis A21 of the mobile 21.

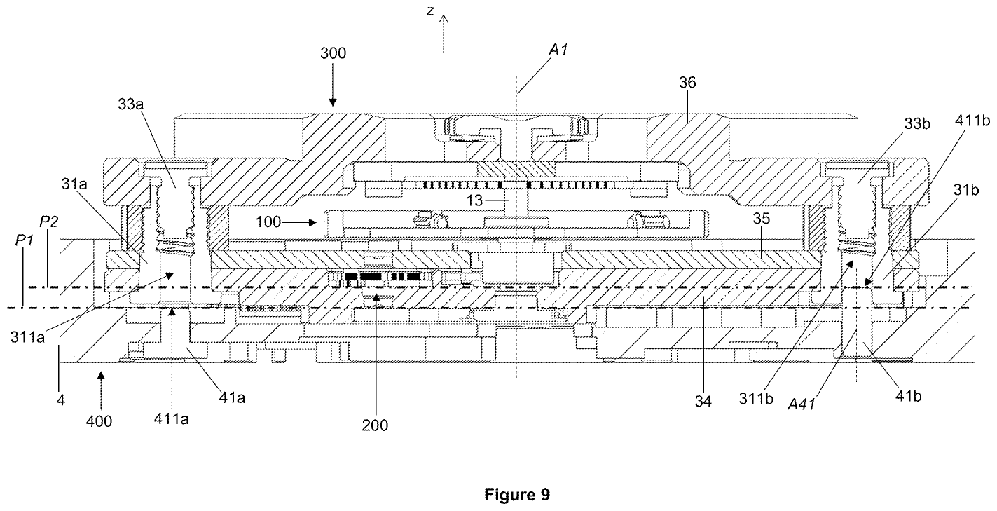

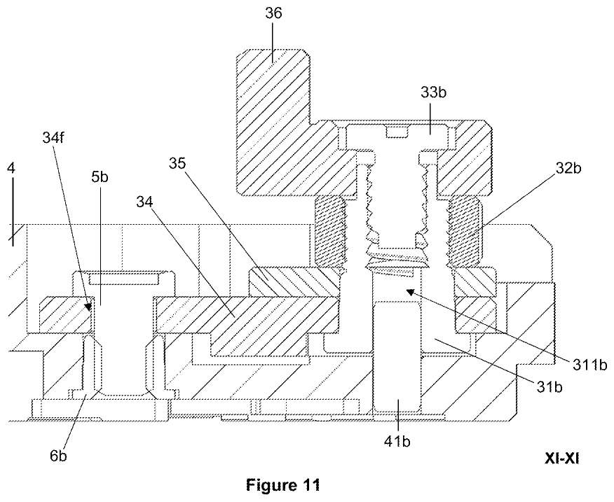

More particularly, the method for mounting the module 300 in the movement 400 comprises the following steps:
A step of supplying a timepiece module 300.
A step of supplying a frame 99, particularly a mainplate 4.
A step of introducing the pin 41b into the opening 311b of the screw-foot 31b in a vertical direction and in an opposite sense to that of the vector z (oriented from the bridge 34 toward the bridge 36 as indicated in FIG. 8) until the module 300 comes to bear against the mainplate 4, and in particularly until a transitory bearing surface 34c of the bridge 34 comes to bear against a transitory bearing surface 4a of the mainplate 4 (as visible in FIG. 8). Thus, the timepiece module 300 is mounted pivoting on the frame 99, particularly the mainplate 4, notably so as to pivot about the positioning element 41b.
A second step involves pivoting the module 300 about the axis A41, the module 300 bearing against the mainplate 4 by virtue of the collaboration of the surfaces 4a, 34c, until the opening 311a of the screw-foot 31a comes to face the pin 41a (as visible in FIG. 9). In this configuration, the tooth set of the pinion 21a is in mesh with that of the wheel 9, as depicted in FIG. 10. Angular abutment surfaces 34g, 42 may for example be provided respectively on the timepiece module 300, particularly on the bridge 34, and on the mainplate 4 in order to avoid any inadvertent damage to these geartrain mobiles as the module 300 is rotated about the axis A41. Advantageously, this second step is rendered possible by the fact that the pins 41a and 41b are not arranged in the same way on the mainplate 4 and/or are not shaped in the same way. Alternatively or in addition, the pins 41a and 41b may be fitted in distinct mounting steps. As a preference, as is more particularly visible in FIG. 9, the respective longitudinal ends 411a, 411b of the pins 41a, 41b that are closest to the module 300 are not positioned in the same plane or at the same level. The end 411a of the pin 41a extends in a plane P1, while the end 411b of the pin 41b extends in a plane P2, P2 being above P1 along the vector z, and P1 and P2 preferably being parallel to the plane P in which the mainplate 4 extends. Thus, the pin 41a does not intersect the plane P2. Thus, when the module 300 is pivoted by the pin 41b and is in contact with the surface 4a, said module 300, particularly the screw-foot 31a, is free to position itself in line with the pin 41a. As a preference, the distinct parallel planes P1 and P2 are parallel to the plane P in which the frame 99 extends and/or the distinct planes P1 and P2 are perpendicular to the geometric axis A41 of a positioning element.
Once the screw-foot 31a has been placed in line with the pin 41a, a third step that involves introducing the pin 41a into the opening 311a is performed, until a bearing surface 34d of the bridge 34 comes to bear against a bearing surface 4b of the mainplate 4 (as visible in FIGS. 4 and 5). The timepiece module 300 is thus positioned relative to the frame 99 by means of the positioning elements 41a, 41b. Advantageously, the positioning of the timepiece module 300 relative to the frame 99 involves moving the timepiece module 300 relative to the frame in a direction parallel to the axis of the pin 41a.
A fourth step consisting in fixing the module 300 on the movement 400 is then performed. This step may, for example, be performed by means of two screws 5a, 5b intended to become housed in, and in particular intended to pass through, openings 34e, 34f of the module 300, particularly of the bridge 34. The screw threads of the screws are intended to collaborate with tapped threads formed in the screw-feet 6a, 6b fixed to the mainplate 4, notably by driving in (as visible in FIGS. 10 and 11).

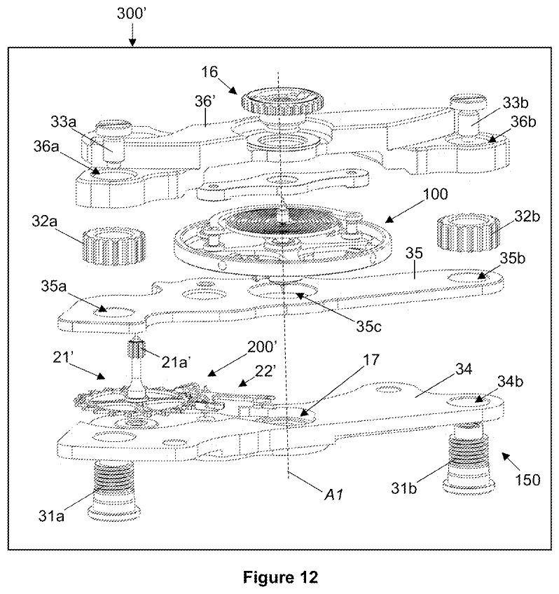

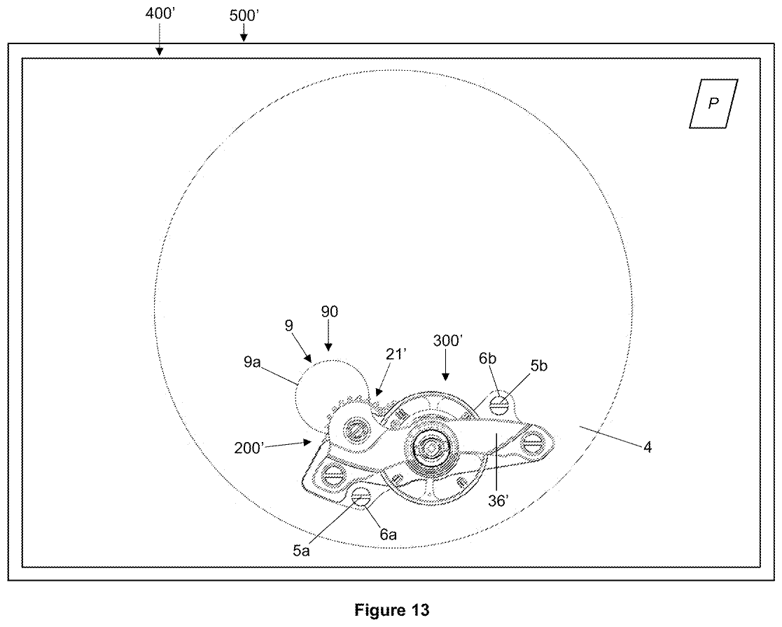

A second embodiment of a timepiece 500′ is described in detail hereinafter with reference to FIGS. 12 and 13. The timepiece 500′ is, for example, a watch, in particular a wristwatch. The timepiece 500′ comprises an assembly 400′, particularly a timepiece movement 400′, intended to be mounted in a timepiece case or casing in order to protect it from the external environment. The timepiece movement 400′ may be a mechanical movement, notably an automatic movement, or else a hybrid movement.

The assembly 400′ comprises a timepiece module 300′ and a timepiece movement frame 99, notably a timepiece movement bridge or a timepiece movement mainplate 4. The timepiece module is advantageously positioned and fixed on the frame. For example, the timepiece module 300′ may be a regulating system module. This module may be designed to be assembled in the movement 400′ of the timepiece 500′, particularly on the frame 99, notably on a mainplate 4 of said movement. The module advantageously comprises an oscillator 100, and an escapement device 200′. As a preference, the oscillator 100 takes the form of an oscillator comprising a balance and a balance spring and assembled on an arbor or staff the geometric axis of which is perpendicular to a plane P in which the mainplate 4 of the movement 400′ extends.

For example, the escapement device 200′ takes the form of a Swiss lever escapement, notably an escapement like the one that forms the subject matter of application EP2336832.

FIG. 12 illustrates a module 300′ incorporating such an escapement device 200′. The latter comprises an escapement mobile 21′ and a blocker 22′ collaborating with an oscillator 100 like the one described hereinabove. The elements 21′ and 22′ here have a structure that is entirely conventional. The bridge 36′ on the other hand has the special feature of pivoting, besides the oscillator 100, the escapement mobile 21′ at one of its ends.

After the manner of the first embodiment, the positioning elements 31a, 31b are two in number within this second embodiment. Alternatively, the number of positioning elements may be different, notably three. As a preference, the positioning elements are screw-feet 31a, 31b.

The assembling of the module 300′ within the movement 400′ (illustrated in FIG. 13) is itself performed in the same way as the module 300 is assembled within the movement 400.

The embodiments described relate to regulating system timepiece modules. However, the invention may be applied to the creation of a module for pivoting of a timepiece mobile or of several timepiece mobiles of any other type. For example, it could act as a module serving as a finishing geartrain or else as an automatic module. The invention is thus equally applicable to an electronic timepiece movement.

The modules described have the particular feature of comprising positioning means for the positioning on a frame of the movement, which means also act as means for the relative positioning of at least two bridges that form part of said module, said module being fixed to the frame of the movement by means different than the positioning means.

What is meant here by a “module” is an autonomous module, namely a module that is sufficient in itself and allows the assembly, particularly the pivoting, of elements independently of the frame of the movement within which it is intended to be assembled, or any other module within said movement. This is notably made possible by the fact that the module is fixed to the frame of the movement by ancillary means different than the positioning means. Advantageously, a module comprises bridges 34, 35, 36; 34, 35, 36′ in which there are guided, particularly guided exclusively by said module, one or more timepiece components 100, 21, 22a, 22b; 100, 21′, 22′. The module is attached, particularly fixed, at one or more bridges 34, 35, 36; 34, 35, 36′, on the main frame 99, particularly the mainplate 4, of the timepiece movement, in order to constitute the timepiece movement.

Whatever the embodiment or embodiment variant described, the positioning elements 31a, 31b take the form of screw-feet 31a, 31b which also act as fixing elements for fixing at least one bridge 36; 36′ to a bridge or a base 34 of the module 300; 300′. However, as an alternative, the fixing elements for fixing at least a first bridge on a second bridge of the module could be different than the positioning elements for positioning the at least a first bridge on the second bridge. For example, the positioning elements could take the form of pins, notably pins fixed to the bridge 34 or formed as one with the bridge 34, and the fixing elements could take the form of tapped holes formed for example in the bridge 34 and intended to collaborate with the second fixing elements 33a, 33b, particularly the screws 33a, 33b. As a further alternative, the fixing elements could take the form of simple holes into which second fixing elements, particularly rivets, are intended to be inserted.

Moreover, these fixing elements could fix the bridges 34, 35, 36; 36′, and do so without first fixing elements 32a, 32b, particularly spacers 32a, 32b.

Whatever the embodiment or embodiment variant described, openings 311a, 311b in the positioning elements 31a, 31b are intended to collaborate with protruding positioning elements 41a, 41b taking the form of pins 41a, 41b fixed to the mainplate 4 of the movement. As an alternative, the positioning elements 41a, 41b could take the form of openings formed in the mainplate 4 and which are each intended to collaborate with an exterior portion formed at each of the positioning elements 31a, 31b.

The positioning elements 31a, 31b could moreover be fixed to the bridge 35 or 36; 36′ as an alternative to the bridge 34. The positioning elements 31a, 31b may be formed as one with one of the bridges or fixed permanently (notably welded, brazed, bonded or riveted) to one of the bridges. In such an instance, the permanent connection between the positioning elements 31a, 31b and one of the bridges ensures the positioning of the positioning elements relative to the bridge to which they are attached. The permanent connection therefore constitutes a first positioning portion for the positioning of the first bridge or a second positioning portion for the positioning of the second bridge.

As a preference, whatever the embodiment or embodiment variant, the positioning elements 31a, 31b are each of one piece and/or have the form of a post or a spacer defining a distance between two bridges.

The fixing elements 5a, 5b, 6a, 6b for fixing the timepiece module 300; 300′ to the mainplate 4 preferably take the form of screws and screw-feet. Of course, any other method of fixing may be used. For example, the fixing elements could take the form of rivets and simple holes.

The timepiece module 300; 300′ advantageously comprises there bridges 34, 35, 36; 34, 35, 36′. Naturally, the module 300; 300′ could comprise just two bridges 34, 36; 34, 36′. The bridge 36; 36′ would then pivot and/or limit both the oscillator 100 and the elements 21; 21′, 22a, 22b; 22′ of the escapement device 200; 200′.

In the foregoing description, the mounting of a timepiece module 300; 300′ on a timepiece frame, particularly a movement, has been described in its application to the mounting of a timepiece module according to the invention. However, this method of mounting is also applicable to any other timepiece module that is not structured in accordance with the invention.

The traditional mounting of a regulating system within a timepiece movement requires a certain number of adjustments, both of the oscillator and of the escapement device. For example, the axial clearance of the oscillator between a balance bridge and a mainplate requires fine adjustment, and the penetrations of an escapement blocker with respect to an escapement wheel need to be adjusted, and the escapement device may require fine positioning. By virtue of the invention, it is possible to create a regulating system module that can easily be incorporated into a movement. Such a module advantageously allows the adjustments to be made upstream of the assembling of the regulating system into the movement. Moreover, the specific configuration thereof allows very precise assembly of the elements involved in the module and very precise assembly of the module on the movement, notably to allow optimal collaboration between the elements of the basic movement and the elements of the module.

The solutions described offer the particular feature of comprising means for positioning the module on the frame of a movement that also act as means for the relative positioning of the bridges that form part of said module. Such a configuration advantageously allows the chains of dimensions to be minimized as far as possible. According to a variant of these solutions, the means for positioning the bridges may also act as means for positioning a balance spring of an oscillator of the balance/balance spring type.

1. A timepiece module comprising:
a mobile,
a first bridge,
a second bridge, and
a positioning system for positioning the second bridge on the first bridge,
the positioning system comprising positioning elements, each of the positioning elements comprising:
a first positioning portion for positioning the first bridge,
a second positioning portion for positioning the second bridge, and
a third positioning portion able to position the positioning element relative to a frame.

2. The timepiece module as claimed in claim 1, wherein the positioning system comprises second fixing elements for fixing the second bridge on the first bridge, each of the second fixing elements collaborating with a second fixing portion provided on each of the positioning dement elements.

3. The timepiece module as claimed in claim 1, wherein the first positioning portion is a cylindrical or partially cylindrical portion intended to collaborate with a first opening provided in the first bridge.

4. The timepiece module as claimed in claim 1, wherein the second positioning portion is a cylindrical or partially cylindrical portion intended to collaborate with a second opening provided in the second bridge.

5. The timepiece module as claimed in claim 1, wherein the third positioning portion is a cylindrical or partially cylindrical portion intended to collaborate with a protruding element provided on or attached to a frame.

6. The timepiece module as claimed in claim 1, wherein the positioning elements are screw-feet.

7. The timepiece module as claimed in claim 1, wherein the timepiece module comprises a third bridge positioned between the first bridge and the second bridge.

8. The timepiece module as claimed in claim 7, wherein the positioning elements each comprise a fourth positioning portion for positioning the third bridge.

9. The timepiece module as claimed in claim 1, wherein the positioning system comprises first fixing elements each collaborating with a first fixing portion provided on each positioning element.

10. The timepiece module as claimed in claim 1, wherein at least one of the following:
the timepiece module is a regulating system module,
the mobile is an oscillator.

11. The timepiece module as claimed in claim 1, wherein the timepiece module further comprises an escapement device.

12. An assembly comprising a timepiece module as claimed in claim 1 and a frame.

13. The assembly as claimed in claim 12, wherein the frame comprises two positioning elements in the form of protruding elements arranged so as to have respective longitudinal ends positioned in distinct parallel planes.

14. A timepiece comprising a timepiece module as claimed in claim 1.

15. A method for assembling an assembly, the method comprising:
providing a timepiece module as claimed in claim 1;
providing a frame;
mounting the timepiece module so that the timepiece module can pivot on the frame;
positioning the timepiece module in a fixing position relative to the frame using positioning elements; and
fixing the timepiece module in the fixing position relative to the frame.

16. The timepiece module as claimed in claim 1, wherein the third positioning portion is able to position the positioning element relative to a bridge or to a mainplate.

17. The timepiece module as claimed in claim 2, wherein the second fixing elements are screws, and each of the second fixing portions is a tapped hole.

18. The timepiece module as claimed in claim 3, wherein the first opening is a first bore.

19. The timepiece module as claimed in claim 4, wherein the second opening is a second bore.

20. The timepiece module as claimed in claim 4, wherein the protruding element is
